(19) United States
(12) Patent Application Publication
(10) Pub. No.: US 2026/0169803 A1
(43) Pub. Date: Jun. 18, 2026

(54) BATCH JOINING OF COMPUTING NODES TO A CLUSTER

(71) Applicant: Dell Products L.P., Round Rock, TX (US)

(72) Inventors: David T. Leimbach, Everett, WA (US); Steven Soumpholphakdy, Austin, TX (US)

(21) Appl. No.: 18/981,363

(22) Filed: Dec. 13, 2024

(51) Int. Cl. G06F 9/50

(52) U.S. Cl. CPC G06F 9/5027; G06F 9/5072

(57) ABSTRACT

A computing system may receive identifiers associated with a batch of computing resource storage nodes to be added to a cluster of computing resource nodes. All of the nodes may be merged to the cluster at once for a new cluster. To add the nodes to an existing cluster that is operative in an active computing system environment, the computing system may indicate the nodes one-at-a-time to an operating system corresponding to the cluster. The cluster operating system may determine a consensus, based on nodes that have already been merged to the cluster, with respect to the indicated node to avoid potentially undermining ability to determine a consensus. As a consensus is determined with respect to one node, a next node of the batch of nodes may be indicated to be merged with the cluster until the new nodes to be added are merged with the active cluster.

### BACKGROUND

A cloud computing service provider may make various computing resources, for example, software as a service, virtual machines, storage, bare metal computing hardware, or even a complete enterprise's infrastructure and development platforms, available over a communication network. A cloud services provider may make a public cloud computing resource available to users over a publicly accessible network, such as, for example, the Internet. A private cloud computing resource may be available or accessible only by a particular customer, such as, for example, an enterprise and its employees. Computing resources may be provided from an enterprise customer's on-premises data center or from a data center operated by an independent (e.g., independent with respect to the enterprise customer) cloud services provider. A hybrid cloud may connect an organization's private cloud services and resources of public clouds into an infrastructure that facilitates the organization's applications and workloads in a manner that balances the maximizing of performance and the minimizing of costs.

Cloud providers, whether public or private, may use clustering of servers. A server cluster may comprise computing system servers that share an Internet Protocol (“IP”) address. Clustering may enhance data protection, availability, load balancing, and scalability. A server associated with a cluster may be referred to as a node, which may comprise a hard drive, a solid-state drive, random access memory (“RAM”), or central processing unit (“CPU”) resources. If a server within a cluster fails, another server can automatically, or semiautomatically, take over for the failed server, thus reducing downtime and outages experienced by users and providing uninterrupted, or minimal interruption, of access to server related resources. To increase resource capacity, nodes may be added to a cluster.

In a cloud environment, it is desirable to have failover capabilities with performance specifications, such that if a cloud computing resource fails during an event, such as, for example, a power outage, break in a communication link, or even a failed component, which may be due to a weather event or a seismic event, failover is practically seamless from the perspective of a user of the resource with the user noticing minimal, if any, disruption of his, or her, use of the resource. Failover resources are typically used when an event disables an active primary resource and are typically idle when the primary resource is active and providing service to a user. Cloud resources have a cost associated with them, even when idle. Therefore, it is desirable to facilitate failover capabilities having costs lower than for fully redundant cluster resources but still having acceptable performance (e.g., exceeds performance attainable using typical backup restoration techniques) with minimal disruption.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise receiving, by at least one computing system comprising at least one processor, at least one batch join request to join at least one batch computing resource to at least one computing resource cluster. Responsive to the at least one batch join request, the method may further comprise facilitating, by the at least one computing system, configuring the at least one computing resource cluster to operate with an initial batch computing resource of the at least one batch computing resource. The method may further comprise determining, by the at least one computing system, that the at least one computing resource cluster is configured to operate with the initial batch computing resource. Based on the determining that the at least one computing resource cluster is configured to operate with the initial batch computing resource and responsive to the at least one batch join request, the method may further comprise facilitating, by the at least one computing system, configuring the at least one computing resource cluster to operate with at least one additional batch computing resource, other than the initial batch computing resource, of the at least one batch computing resource.

In an example embodiment, before the determining that the at least one computing resource cluster is configured to operate with the initial batch computing resource, the initial batch computing resource may be associated with an initial operational status indication indicative that the initial batch computing resource may be available to operate as part of the at least one computing resource cluster. The initial operational status indication may be set to ‘true’ to be indicative that the associated initial batch computing resource may be merged with the at least one computing resource cluster or may be considered for purposes of determining a consensus that the initial batch computing resource may be merged with, joined with, added to, or otherwise become an active part of, the at least one computing resource cluster.

In an example embodiment that may be useful in a scenario wherein the at least one batch join request may indicate one or more computing resource nodes to be add to a cluster that has not been put into production (e.g., the cluster is not active or available for use by a customer), before the determining that the at least one computing resource cluster is configured to operate with the initial batch computing resource, the at least one additional batch computing resource may be associated with at least one additional operational status indication indicative that the at least one additional batch computing resource may be available to operate as part of the at least one computing resource cluster (e.g., the at least one additional operational status indication may be set to ‘true’ to be indicative that the at least one additional batch computing resource may be merged with the at least one computing resource cluster or may be considered for purposes of determining a consensus that the initial batch computing resource may be merged with, joined with, added to, or otherwise become an active part of, the at least one computing resource cluster).

In an example embodiment that may be useful in a scenario wherein the at least one batch join request may indicate one or more computing resource nodes to be added to a cluster that has been put into production (e.g., the cluster is active or available for use by a customer), before the configuring the at least one computing resource cluster to operate with the at least one additional batch computing resource, the at least one additional batch computing resource may be associated with at least one additional nonoperational status indication indicative that the at least one additional batch computing resource may not be available to operate as part of the at least one computing resource cluster (e.g., a merge flag corresponding to the at least one additional computing resource may be set to ‘false’), and wherein, after the configuring of the at least one computing resource cluster to operate with the initial batch computing resource, the at least one additional batch computing resource may be associated with at least one additional operational status indication indicative that the at least one additional batch computing resource is available to operate as part of the at least one computing resource cluster (e.g., the merge flag corresponding to the at least one additional computing resource may be set to ‘true’ after a consensus has been determined with respect to the initial computing resource).

The at least one additional batch computing resource may be at least one first additional batch computing resource. The at least one additional nonoperational status indication may comprise at least one first nonoperational status indication indicative that the at least one first additional batch computing resource may not be available to operate as part of the at least one computing resource cluster. The at least one additional operational status indication may comprise at least one first additional operational status indication indicative that the at least one first additional batch computing resource may be available to operate as part of the at least one computing resource cluster. The method may further comprise determining, by the at least one computing system, that the at least one computing resource cluster is configured to operate with the at least one first additional batch computing resource. Based on the determining that the at least one computing resource cluster is configured to operate with the at least one first additional batch computing resource and responsive to the at least one batch join request, the method may further comprise facilitating, by the at least one computing system, configuring the at least one computing resource cluster to operate with at least one second additional batch computing resource, other than the initial batch computing resource and other than the at least one first additional batch computing resource, of the at least one batch computing resource.

In an example embodiment, the at least one batch join request may comprise an initial batch resource indication indicative of the initial batch computing resource, at least one first additional batch resource indication indicative of the at least one first additional batch computing resource, and at least one second additional batch resource indication indicative of the at least one second additional batch computing resource. An initial batch resource indication or an additional batch resource indication may comprise a merge flag setting or a node identifier.

In an example embodiment, the at least one batch join request may comprise an initial batch computing resource identifier associated with the initial batch computing resource, at least one first additional batch computing resource identifier associated with the at least one first additional batch computing resource, and at least one second additional batch computing resource identifier associated with the at least one second additional batch computing resource.

In an example embodiment, the initial batch computing resource identifier may correspond to an initial value. The at least one first additional batch computing resource identifier may comprise at least one first additional value. The at least one second additional batch computing resource identifier may comprise at least one second additional value.

In an example embodiment, the configuring of the at least one computing resource cluster to operate with the initial batch computing resource, the at least one first additional batch computing resource, and the at least one second additional batch computing resource, may be facilitated according to the initial value, the at least one first additional value, and the at least one second additional value, respectively.

In an example embodiment, the at least one computing system may comprise the at least one computing resource cluster.

In an example embodiment, the facilitating of the configuring of the at least one computing resource cluster to operate with the initial batch computing resource, the determining that the at least one computing resource cluster is configured to operate with the initial batch computing resource, and the facilitating of the configuring of the at least one computing resource cluster to operate with the at least one additional batch computing resource may be independent of any user input or human intervention.

In an example embodiment, the at least one computing resource cluster may be determined to be configured to operate with the initial batch computing resource or the at least one additional batch computing resource according to a configured merge computing resource acknowledgement frequency.

In another example embodiment, a computing system may comprise at least one processor configured to process executable instructions that, when executed by the at least one processor, may facilitate performance of operations that may comprise, responsive to at least one batch join request to join at least one batch computing resource to at least one computing resource cluster, configuring the at least one computing resource cluster to operate with a first batch computing resource of the at least one batch computing resource and determining that the at least one computing resource cluster is configured to operate with the first batch computing resource. Based on the determining that the at least one computing resource cluster is configured to operate with the first batch computing resource, responsive to the at least one batch join request, the operations may further comprise configuring the at least one computing resource cluster to operate with a second batch computing resource of the at least one batch computing resource.

Before the determining that the at least one computing resource cluster is configured to operate with the first batch computing resource, the second batch computing resource may be associated with a first nonoperational status indication indicative that the second batch computing resource has not been indicated as being capable to merge with the at least one computing resource cluster. After the determining that the at least one computing resource cluster is configured to operate with the first batch computing resource, the operations may further comprise setting a first merge flag associated with the second batch computing resource to be indicative that the second batch computing resource is capable of being merged with the at least one computing resource cluster. The configuring of the at least one computing resource cluster to operate with the second batch computing resource may be based on the first merge flag being indicative that the second batch computing resource is capable of being merged with the at least one computing resource cluster.

In an example embodiment, the configuring of the at least one computing resource cluster to operate with the first batch computing resource may comprise a first consensus, corresponding to the at least one computing resource cluster, being determined that the first batch computing resource has been accepted for operation with respect to the at least one computing resource cluster.

In an example embodiment, the configuring of the at least one computing resource cluster to operate with the second batch computing resource may comprise a second consensus being determined that the second batch computing resource has been accepted for operation with respect to the at least one computing resource cluster. The second consensus may not be determined, or attempted to be determined, until after the first batch computing resource has been joined to the at least one computing resource cluster.

In an example embodiment, the at least one computing resource cluster may comprise at least one cluster node. The first batch computing resource and the second batch computing resource may comprise, or may compose, first and second cluster nodes, respectively, indicated by the at least one batch join request to be added to the at least one computing resource cluster.

In yet another example embodiment, a non-transitory machine-readable medium may comprise executable instructions that, when executed by at least one processor of a computing system, may facilitate performance of operations that may comprise, responsive to at least one batch join request, comprising a first computing resource node indication associated with a first computing resource node and a second computing resource node indication associated with a second computing resource node, to join the first computing resource node and the second computing resource node to a computing resource node cluster, determining a first consensus, corresponding to the first computing resource node, to join the first computing resource node to the computing resource node cluster. The operations may further comprise updating the first computing resource node indication to be indicative that the first computing resource node has been joined to the computing resource node cluster and to result in a first updated computing resource node indication. Based on the first updated computing resource node indication being indicative that the first computing resource node has been joined to the computing resource node cluster, the operations may further comprise determining a second consensus to join the second computing resource node to the computing resource node cluster. The operations may further comprise updating the second computing resource node indication to be indicative that the second computing resource node has been joined to the computing resource node cluster and to result in a second updated computing resource node indication.

In an example embodiment, the first consensus may be determined with respect to the first computing resource node. The first consensus may not be determined with respect to the second computing resource node (e.g., the second node may not be considered in determining a consensus with respect to the first node). The second node may correspond to a second computing resource node indication corresponding to the second computing resource node. Consensus with respect to the second node may be determined, according to an order of the first computing resource node indication and the second computing resource node indication, after a consensus with respect to the first node is determined. In an embodiment, the order of the first and second computing resource node indications may be based on, or indicated by, the at least one batch join request. Indication(s) of the first node or second node may correspond to unique identifiers corresponding to the node(s).

In yet another example embodiment, a non-transitory machine-readable medium may comprise executable instructions that, when executed by at least one processor of a computing system, may facilitate performance of operations that may comprise, responsive to at least one batch join request, comprising a first computing resource node indication associated with a first computing resource node and a second computing resource node indication associated with second computing resource node, to join the first computing resource node and the second computing resource node to a first computing resource node cluster and indicative that neither the first computing resource node nor the second computing resource node is part of the first computing resource node cluster, determining that a first consensus, corresponding to the first resource node cluster, has been determined, based on the first computing resource node indication, to join the first computing resource node resource to the first resource node cluster. The operations may further comprise updating the first computing resource node indication to be indicative that the first computing resource node has been joined to the first computing resource node cluster to result in a first updated computing resource node indication. Based on the first updated computing resource node indication being indicative that the first computing resource node has been joined to the first computing resource node cluster, the operations may further comprise determining that a second consensus, corresponding to a second computing resource node cluster that comprises the first resource node cluster and the first computing resource node, has been determined to join the second computing resource node to the second computing resource node cluster. The operations may further comprise updating the second computing resource node indication to be indicative that the second computing resource node has been joined to the second computing resource node cluster to result in a second updated computing resource node indication.

### BRIEF DESCRIPTION OF THE DRAWINGS

FIG. 1 illustrates an exemplary system with a computing resource cluster with multiple computing resource nodes.

FIG. 2 illustrates an exemplary system with multiple computing resource nodes being added as a batch to a non-deployed computing resource cluster.

FIG. 3 illustrates an exemplary system with multiple computing resource nodes being added as a batch to a deployed computing resource cluster.

FIG. 4 illustrates a timing diagram of an example method to add multiple computing resource nodes as a batch to a non-deployed computing resource cluster.

FIG. 5 illustrates a timing diagram of an example method to add multiple computing resource nodes as a batch to a deployed computing resource cluster.

FIG. 6 illustrates a flow diagram of an example method to add multiple computing resource nodes as a batch to a computing resource cluster.

FIG. 7 illustrates a computer environment.

FIG. 8 illustrates a block diagram of an example method.

FIG. 9 illustrates a block diagram of an example computing system.

FIG. 10 illustrates a block diagram of an example non-transitory machine-readable medium.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is only illustrative and exemplary of one or more concepts expressed by the various embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

A computing resource cluster may comprise at least one computing chassis in at least one physical data center with each chassis comprising at least one computing resource node that may comprise, and that may be optimized to provide computing storage resources (e.g., a node may comprise a computing system that may be configured to provide a large amount of storage capability). A node may be constructed as rack-mountable enterprise appliances containing memory resources, at least one processor, networking and connectivity capability, (e.g., Ethernet or QDR InfiniBand), and storage media. A cluster may comprise many nodes, for example a cluster may comprise more than 250 nodes.

In an example embodiment, a single file system that is distributed across multiple nodes or multiple clusters may have a capacity of tens of terabytes, or even tens of petabytes, and may support large individual files, for example files having size up to 16 TB or more. Adding a node to a cluster may increase aggregate disk capacity, cache capacity, processor capacity, and network capacity corresponding to the cluster.

To facilitate proper operation of a computing resources cluster, a quorum, or majority, of nodes that are active and responding to messages corresponding to the cluster is typically needed. A file operating system, which may be referred to as a distributed-file operating system, that facilitates a single file system that is distributed among multiple nodes, or multiple clusters of nodes, such as, for example, OneFS offered by Dell Inc., may use a quorum consensus criterion to facilitate actions or changes occurring with respect to nodes that are part of a cluster. For example, if problems occur with respect to a number of nodes associated with a cluster such that there are an insufficient number of active, responsive, nodes to form a quorum, a change in member nodes of the cluster may be prevented from occurring.

To avoid compromising consistency with respect to a cluster, a simple quorum may be required to prevent partitioning, or a ‘split-brain’ condition, that could occur if the cluster were to temporarily divide into two clusters. A quorum criterion may facilitate, regardless of how many nodes fail or come back online with respect to a cluster, that if, for example, a write operation takes place, the write can be made consistent with previous write operations that may have occurred. A cluster quorum criterion being satisfied may facilitate a number of active nodes being required to perform an action with respect to the cluster associated with a defined protection level. For example, for an erasure-code (FEC) based protection-level of N+M, a cluster must contain at least 2 M+1 nodes. If, for example, a minimum of seven nodes is required for a +3n protection level, a simultaneous, or concurrent, loss of three nodes could occur while a quorum of the remaining four nodes corresponding to the cluster remain operational. If a count of active nodes corresponding to a cluster drop below a quorum corresponding to the cluster, the file operating system may be placed into a protected, read-only state, for example, and may deny writes but may still allow read access to data that may be stored by the remaining active nodes.

To avoid, or minimize, compromising consistency with respect to operation of a cluster, a transient state and quorum corresponding to the cluster may be actively managed. For example, a group management protocol, such as, for example, Group Management Protocol (“GMP”) offered by Dell Inc., may facilitate creating and maintaining a group of synchronized nodes. A group may comprise a defined set of nodes that may be in a state of synchronization, and a cluster may comprise different groups as a connection state corresponding to the cluster changes. Use of a quorum criterion with respect to a group management protocol group may facilitate group consistency with respect to node disconnects or other transient events. Having a consistent view of the cluster state may facilitate an initiator module having information regarding one or more nodes or drives to which data may be written.

A negative effect to a workflow corresponding to a cluster may be the effect that may result from group changes such as adding, removing, or rebooting a node, or that may result from hardware failure or from a hardware transient. Information indicative of group state and changes corresponding to a cluster may facilitate managing clusters, especially as cluster size and number of nodes corresponding to a cluster increases, may facilitate determining current health of a cluster, and may facilitate reconstruction of cluster history when troubleshooting issues that may relate to cluster stability or network health. A group management protocol module may facilitate distributing to members of a group a variety of state information, regarding, for example, nodes and drives, that may comprise identifiers or usage statistics. The group management protocol may facilitate distribution of information regarding composition of a group, or cluster, which information may be referred to as a ‘static aspect’ of the group or cluster, which a background function or process may manage, and which may be stored in a static information file. Similarly, the state of a node's drives, or storage components, may be stored in a drive information file along with a flag indicating whether the drive is an SSD. A difference between management of nodes and drives is that with respect to nodes, the static aspect is distributed to every node whereas state information corresponding to a drive is typically stored locally only at a node comprising, or corresponding to, the drive. A group change operation facilitated by a group management protocol module may facilitate changing a cluster-wide shared state. A ‘merge’ may refer to a group change operation according to which nodes may be added to a group or cluster. A merge operation may affect cluster availability due to a cluster's need to pause file system operations during the merge operation. Node state information may be used by every node in a group or cluster to facilitate the group/cluster forming connections based on one or more nodes being added by the merge operation.

After a first boot of a cluster of nodes, or after a reboot of a cluster of nodes, the first node to mount is typically assigned to a single-member group, with all other nodes marked, or flagged, as being ‘down’ or inactive. As connections are formed between nodes, the group management protocol may merge the connected nodes, thus enlarging the group/cluster until a configured cluster is fully represented. A group transaction wherein a node transitions from a ‘down’, or inactive, state to an ‘up’, or active, state may be referred to as a ‘merge’ transaction, or operation, whereas a node transitioning from an up state to a down state may be referred to as a ‘split’ transaction/operation. A consensus protocol, such as, for example, Paxos, may be used to facilitate determining agreement with respect to a cluster-wide result among a group that may comprise one or more transient nodes (e.g., one or more nodes failing, splitting from the group, being added to the group, etc.).

According to conventional techniques, node identifiers associated with nodes to be joined to a cluster may be provided to a file operating system one at a time (or very few at a time) to preserve a quorum with respect to nodes that correspond to the cluster. Providing node identifiers one-by-one may result in a negative effect on the usability of a file operating system and may result in slow formation of a large cluster before the cluster is deployed into a production environment. According to novel embodiments disclosed herein, regardless of whether a cluster is already in production/operation, the speed of cluster formation may be increased and a user experience may be improved via a batch join request. Embodiments disclosed herein may facilitate “throttling” new nodes, indicated by a batch join request, from being presented to the cluster infrastructure backend all at once.

According to conventional techniques to serially present nodes to be added to a cluster one-by-one, a user may indicate each node of multiple nodes to be joined to a cluster via a user interface and the user may manually confirm that a group management protocol module has indicated that a new node has merged with the cluster before the user indicates a next node to be added to, joined to, or merged with, the cluster (e.g., the user may indicate nodes one-by-one based on a list of node identifiers associated with the multiple nodes to be joined to the cluster). Manually indicating nodes to a group management module one-by-one is a safe process insofar as an individual may confirm that a node has been joined to a cluster before indicating another node to be merged with the cluster thus minimizing, or avoiding, the possibility of multiple nodes being associated with the cluster without the multiple nodes to be added having been activated and actually merged with, or accepted by cluster, which merging or accepting may be determined by a group management protocol module that may manage operation of the cluster. Thus, according to conventional techniques, a risk of nodes not merging as they are added and thus causing a loss of quorum with respect to the cluster is minimized or avoided because a node added is seen as down by the group management protocol module until the node merges with the majority group of nodes.

According to example embodiments disclosed herein, a virtual staging area may facilitate adding nodes to the staging area as a batch and the nodes added to the virtual staging area may be gradually joined, added, or merged with a cluster by the group management protocol module. A tag, or flag, may be associated with each node to be added as a batch indicating whether a node is “clear to merge” or not (the flag/tag may be referred to as a merge flag or a merge indicator). A merge flag corresponding to each node to be joined to a cluster may be set to false. When a cluster, or group, is booted or rebooted, a booting process may filter all “merge false” nodes out of a mount process. Additionally, nodes associated with a “merge” flag set to ‘false’ may be sorted according to a device identifier. A merge flag corresponding to a node may be set to ‘true’ as a consensus protocol determines a consensus with respect to the node. With respect to the consensus determination, a node currently being added (e.g., a node corresponding to a node identifier that is at the top of, or next in, a sorted list of node identifiers) may be deemed as a proposer. If a node that is deemed a proposer cannot perform activities that are normally performed by a proposer with respect to a consensus determination, a likelihood exists that something is wrong with the node and the node should not be merged with the cluster. After a node has been deemed as a proposer, the node identifier may be removed from the sorted list of node identifiers. Accordingly, a batch of node identifiers may be input by a user for processing by a group management protocol module without the user having to manually input identifiers one-by-one as confirmation is received by the user that a group management protocol module has indicated that a node corresponding to a previously input node identifier has been added to the cluster. Although a user may provide a batch of node identifiers corresponding to nodes to be merged with a cluster, by automatically flipping, by a computing system, a merge flag from ‘false’ to ‘true’ with respect to a node to determine consensus with respect to the node, cluster outages, with respect to a cluster to which the node is to be added as part of a batch, that could be caused by loss of a quorum may be minimized or avoided. If a cluster is not in production yet or is being initially set up, merge flags corresponding to nodes to be added to the cluster as a batch may all be set to ‘true’ to facilitate forming the cluster quickly since achieving a quorum with respect to a cluster being formed or that is not deployed yet in a production environment may not be important.

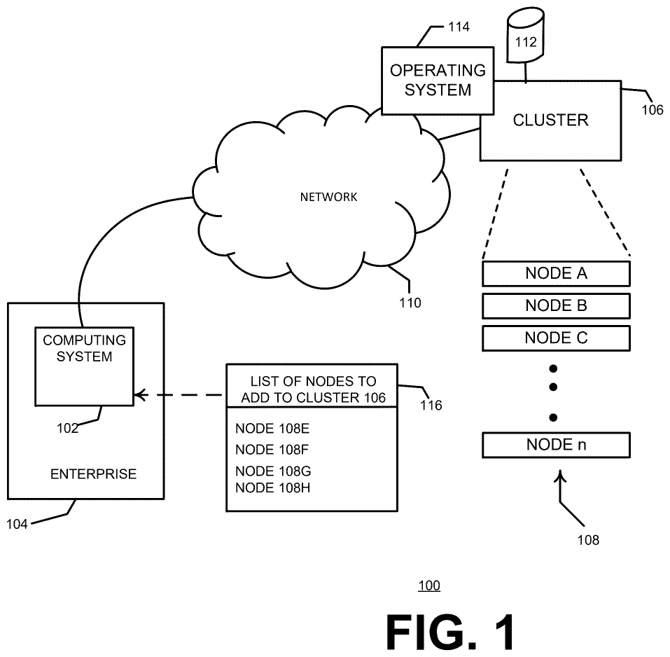

Turning now to FIG. 1, the figure illustrates computing system environment 100 comprising computing system 102 that may correspond to an enterprise 104. Computing system 102 may be a computing system of an information technology (“IT”) group corresponding to enterprise 104, or computing system 102 may be a computing system of a computing system services provider that may provide computing services to other enterprises via communication network 110, which may comprise, for example, the Internet. Computing system 102 may be used to configure computing resources cluster 106, which may comprise one or more computing resource nodes 108. Cluster 106 may comprise, may correspond to, or may be associated with, at least one storage component 112. A storage component 112 may comprise at least one storage device, for example, a tape drive, a disc drive, a solid-state, drive, or the like. Each of nodes 108A-108n may comprise at least one separate storage component 112. Operating system 114 may manage the operation of cluster 106 or nodes 108. A node 108 may comprise a complete computing system that comprises processing resources, storage resources, memory resources and other computing resources typically associated with a stand-alone computing system. Cluster 106 may comprise multiple nodes in multiple rack spaces in multiple racks located at at least one data center.

When cluster 106 is initially established, or after the cluster has been established and more nodes are to be added to the cluster to expand or enhance computing capabilities corresponding to the cluster, nodes 108 may be added to the cluster. A process of adding nodes 108 to cluster 106 may comprise, under management or control of operating system 114, determining a consensus by, or corresponding to, nodes that are already members of, or that already have been configured to operate with, the cluster. A consensus may correspond to a majority of nodes that have been configured to operate with cluster 106 acknowledging, or ‘accepting’, another node to become a member of, or to become associated with, the cluster. A node may be indicated by computing system 102 as being available to merge with other nodes 108 that are already part of cluster 106. Thus, from the perspective of nodes 108A-08n that are already members of, or that are already associated with cluster 106, a node to be added to the cluster may be indicated as being available to become a member of the cluster, but until a consensus is reached to add the new node to the cluster the node to be added may not be active with respect to the cluster (e.g., the node to be added may be ‘down’ with respect to the cluster). Thus, a node 108 may be added to cluster 106 by computing system 102 one-by-one to facilitate being able to determine consensus of nodes that have been configured to operate as part of the cluster, otherwise if too many nodes to be added to the cluster are indicated as being part of the cluster but are in actuality inactive with respect to the cluster because consensus has not then obtained yet such that the nodes to be added are actually part of the cluster, a consensus that comprises a majority of nodes 108 that are part of the cluster may not be possible. For example, if cluster 106 comprises two nodes 108 that have already been configured as being part of the cluster, and if computing system 102 indicates two more nodes 108 as being available to be added to the cluster, a consensus may be based on determinations made with respect to all four nodes, but if only two nodes have been activated with respect to the cluster a majority of the four nodes may never be reached such that the two nodes to be added may never be added. However, adding a node 108 to cluster 106 takes a certain amount of time and, if multiple nodes are to be added to the cluster one-by-one, a user using computing system 102 may have to manually input identifiers corresponding to new nodes to be added to the cluster and wait for a consensus to be reached with respect to a first node before entering an identifier corresponding to a second node to be added to the cluster. Thus, a problem that may exist when adding multiple nodes to a cluster according to conventional techniques may comprise an inefficient use of a user's time and inefficient use of computing system 102. Moreover, according to conventional techniques, inputting, via computing system 102, multiple identifiers corresponding to multiple nodes 108 to be added to cluster 106 may result in consensus never being reached with respect to the multiple nodes to be added.

Thus, according to embodiments disclosed herein, multiple nodes 108 to be added to cluster 106 may be indicated as a batch, for example by list 116, by computing system 102 with at least one node 108E-108H to be added being indicated as not being available to merge with, or to be added to, cluster 106 (e.g., a flag associated with each of nodes 108E-108H indicative of whether the respective node can merge with cluster 106 being set to false). Nodes listed in list 116 may be part of, or may be referred to as, a batch join request. Nodes identifiers listed in list/request 116 may be input to system 102 by a user of the system or by a computing component associated with, or coupled with, the system.

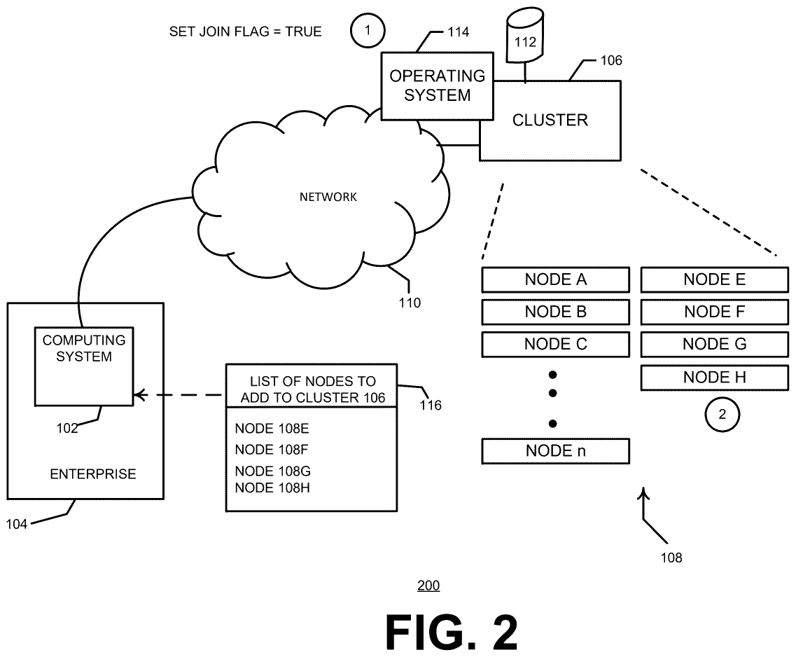

FIG. 2 illustrates an embodiment that may facilitate adding nodes to a cluster that is not already deployed or that is not actively providing computing resources to at least one customer. At act 1, indication of nodes 108E-108H may be provided to operating system 114 to be added to cluster 106. Computing system 102, or operating system 114, may, as a batch, set a flag, or other indicator, associated with each of the nodes 108E-108H listed in list 116, as being available to be joined to cluster 106. At act 2, all nodes 108E-108H may be added to cluster 106 such that cluster 106 is configured to operate with nodes 108E-108H being part of the cluster.

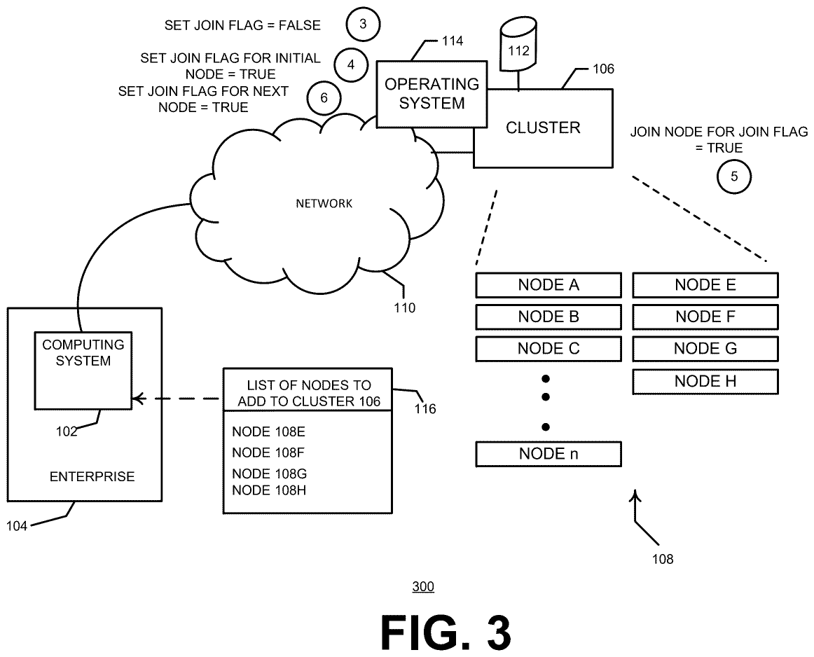

FIG. 3 illustrates an embodiment that may facilitate adding nodes to a cluster that may already be deployed or that may already be actively providing computing resources to at least one customer. At act 3, computing system 102, or operating system 114, may set a merge flag, or other indicator, corresponding to nodes 108E-108H to ‘false’ to indicate that the computing resources/nodes 108E-108H are not available to merge with, or operate as part of, computing resource cluster 106. At act 4, computing system 102 or operating system 114 may, one-by-one, set a merge flag, associated with a node listed by list 116, for example node 108E, as being available to be joined to cluster 106 (e.g., the merge flag corresponding to node 108E may be set to ‘true’ at act 4). In the example, node 108E may be referred to as an initial batch computing resource. The merge flag corresponding to node 108E may be referred to as initial operational status indication that may be indicative that the initial batch computing resource is available to operate as part of computing resource cluster 106. An initial batch computing resource identifier corresponding to node 108E may comprise, for example, a serial number or other unique identifier associated with node 108E. Thus, for example, at act 4, only node 108E of nodes 108E-108H may be indicated as being available to merge with cluster 106 when a consensus of nodes 108 corresponding to cluster 106 is determined. Although node 108E may be unable to actually participate in ‘voting’ on, or determining, a consensus whether to accept node 108E as a member of cluster 106, as long as cluster 106 comprises more than one active node 108 (e.g., more than one node 108A-108C other than node 108E), determining a majority consensus with respect to the more than one active node 108 and the to-be-added node 108E should be possible.

As a node from list 116 is added to, joined with, or merged with, cluster 106 at act 5 and becomes an active member of the cluster, computing system 102 or operating system 114 may, at act 6, set/switch/flip an indicator, or merge/join flag, from ‘false’ to ‘true’ with respect to a next node 108 in list 116, for example node 108 F, and acts 5-6 may be repeated to add nodes 108F-108H to cluster 106. Next node 108F may be referred to as an additional batch computing resource. An additional batch computing resource identifier corresponding to node 108F may comprise, for example, a serial number or other unique identifier associated with node 108F. A merge flag associated with node 108F may be referred to as an additional nonoperational status indication and being set to ‘false’ may be indicative that the at least one additional batch computing resource/node 108F is not available to operate with cluster 106. Setting the merge flag to ‘true’ may be referred to as the additional batch computing resource/node 108F being associated with an additional operational status indication/merge flag that is indicative that the additional batch computing resource/node 108F is available to operate as part of the at least one computing resource cluster. Act 5 through act 6 may be repeated according to an order, for example an order according to which nodes 108E-108H are listed in list 116. As each node 108 indicated by list 116 is indicated at act 3 or act 6 as being available to merge with cluster 106, a consensus with respect to whether to add the node to cluster 106 may be determined. A consensus whether to add a node 108 to cluster 106 may be based on a majority of active nodes 108 that may comprise the node to be added. Nodes 108 of list 116 that have yet to be indicated at act 6 as being available to be merged with cluster 106 and that may not be indicated as an active member of cluster 106 may be excluded from being considered in determining a consensus with respect to the current node to be added to cluster 106 as indicated at act 6. Accordingly, simultaneously considering all nodes-to-be-added that are listed in list 116 when determining a consensus of whether to add a node listed in list 116 may be avoided. Instead, automatically considering nodes from list 116 one-by-one when determining a consensus may avoid all nodes listed by batch join request/list 116 being considered as part of cluster 106 and thus may facilitate avoiding a quorum of active nodes corresponding to the cluster being unachievable for purposes of determining a consensus of whether to add a node 108 listed by list 116. A node to be added may be considered as an inactive node, or a ‘down’ node, and only one node 108F-108H at a time may have a corresponding merge flag indicated as ‘true’ to avoid all inactive/down nodes 108F-108H being indicated as ‘true’ and undermining obtaining a quorum of active or ‘up’ nodes when determining a consensus of whether to merge a node 108F-108H to cluster 106. Computing system 102 may determine computing resource cluster 106 to be configured to operate with the initial batch computing resource (e.g., node 108E) or the additional batch computing resources (e.g., node 108F-108H) according to a configured merged, or added, computing resource acknowledgement frequency, which may be a frequency that cluster 106 is configured to provide updates to computing system 102 regarding the composition of the cluster.

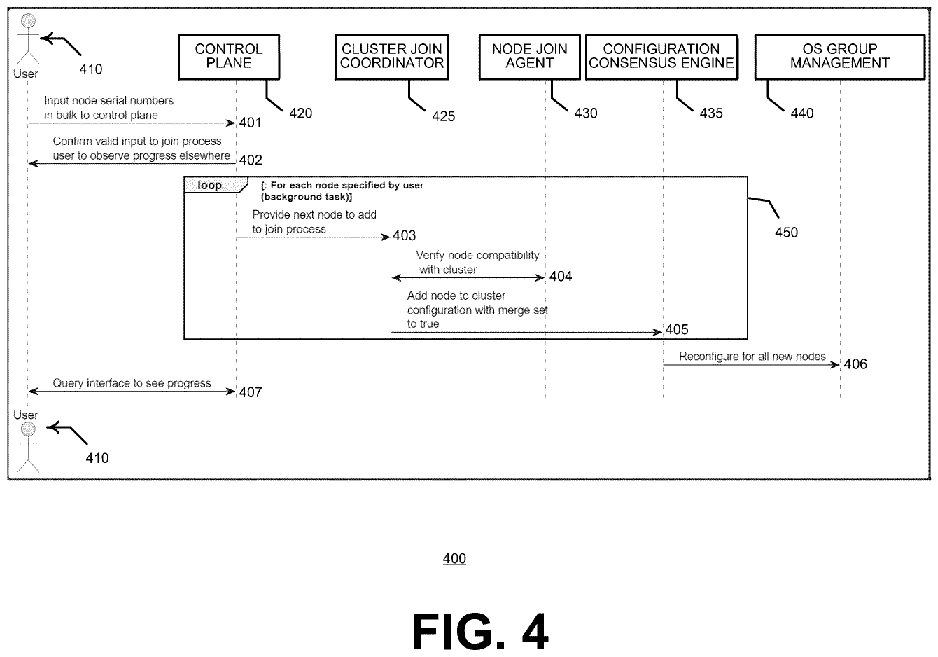

Turning now to FIG. 4, the figure illustrates an embodiment comprising computing environment 400 wherein a user 410 may, at act 401, provide multiple serial numbers, or multiple other indicators, corresponding to multiple computing resource nodes to be added to a computing resource cluster that may not be actively operating (e.g., the user may be configuring a new cluster that has not been use in a production environment). User 410 may use a user interface coupled to control plane components 420. At act 402, at least one control plane component 420 may indicate to user 410 via a user interface that serial numbers entered at act 401 have been received by a component of the control plane. A series of actions, indicated by loop 450, may be performed by at least one of control plane 420, cluster join coordinator 425, node join agent 430, or configuration consensus engine 435. At act 403, a control plane component 420 may provide a serial number, or other indicator, corresponding to serial numbers or other identifiers that were input, by user 410 at act 401, to cluster join coordinator 425. At act 404, cluster join coordinator 425 and node joint agent 430 may coordinate to verify that a computing resource node corresponding to a serial number indicated at act 401 is compatible with a cluster to which the node is to be joined as indicated by user 410 at act 401. At act 405, after a node corresponding to an indicator indicated at act 403 has been verified as being compatible with a cluster to which the node is to be joined, cluster join coordinator 425 may indicate to configuration consensus engine 435 a request-to-join corresponding to the serial number or identifier received act 403. Cluster join coordinator 425 may set a merge flag to ‘true’ at act 405 such that the node corresponding to the node indicator received it at 403 may be considered for being joined to the cluster. Configuration consensus engine 435 may facilitate determining a consensus with respect to the node indicated at act 403. Upon determining a consensus among nodes corresponding to the cluster to which the node indicated at act 403 is to be joined, at act 406 operating system group management component 440, for example a group management protocol module, may configure the cluster to comprise the node indicated at act 403. At act 407, user 410 may monitor an interface to determine progress with respect to the nodes corresponding to the serial numbers or other indicators indicated at 401 being joined to a cluster indicated at act 401. It will be appreciated that after user 410 enters multiple computing resource node serial numbers or no indicators at act 401 user 410 need not monitor progress and need not manually enter the serial numbers one-by-one as the nodes are configured to operate with the cluster during acts 403-406.

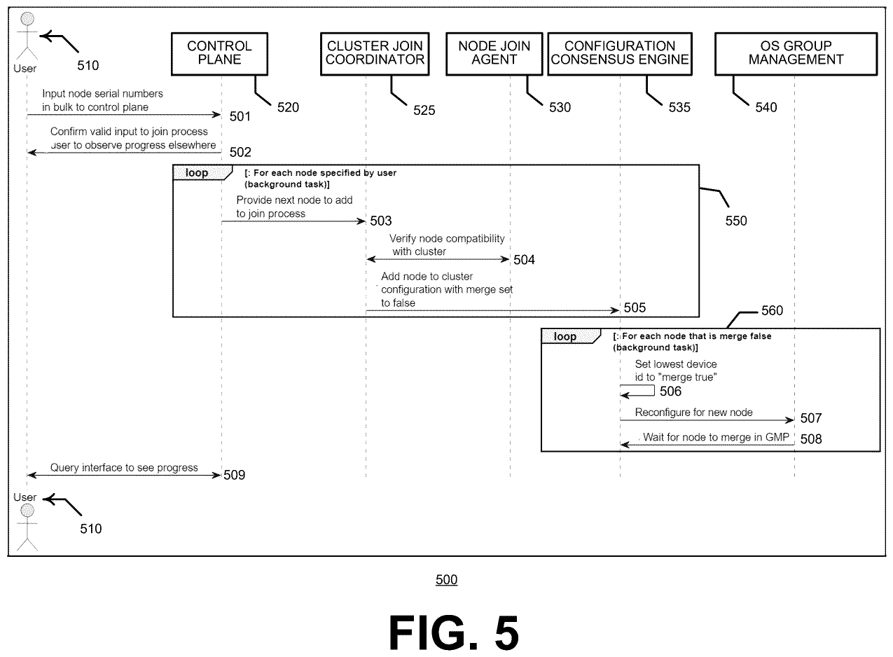

Turning now to FIG. 5, the figure illustrates an embodiment comprising computing environment 500 wherein a user 510 may, at act 501, provide multiple serial numbers, or multiple other indicators, corresponding to multiple computing resource nodes to be added to a computing resource cluster that may be actively operating (e.g., the user may be configuring a cluster that is in use in a production environment). User 510 may use a user interface coupled to control plane components 520. At act 502, at least one component of control plane components 520 may indicate to user 510 via a user interface that serial numbers entered at act 501 have been received by a component of the control plane. A series of actions, indicated by loop 550, may be performed by at least one component of control plane 520, cluster join coordinator 525, node join agent 530, or configuration consensus engine 535. At act 503, a control plane component 520 may provide a serial number, or other indicator, corresponding to serial numbers or other identifiers that were input, by user 510 at act 501, to cluster join coordinator 525. At act 504, cluster join coordinator 525 and node join agent 530 may coordinate to verify that a computing resource node corresponding to a serial number indicated at act 501 is compatible with a cluster to which the node is to be joined as indicated by user 510 at act 501. At act 505, after a node corresponding to an indicator indicated at act 503 has been verified as being compatible with a cluster to which the node is to be joined, cluster join coordinator 525 may indicate to configuration consensus engine 535 a request-to-join corresponding to the serial number or identifier received act 503. Cluster join coordinator 525 may set a merge flag to ‘false’ at act 505 such that nodes corresponding to the node indicators received at act 503 are indicated as being unavailable to be merged with the cluster. After nodes indicated at act 503 have been indicated to configuration consensus engine 535 as being unavailable to merge with the cluster, configuration consensus engine 535 may facilitate determining a consensus with respect to the nodes indicated at act 503 as illustrated by loop 560.

At act 506, configuration consensus engine 535 may set a merge flag corresponding to a first node, of nodes indicated at act 501 and provided at act 503, to ‘true’ and the configuration consensus engine may configure the cluster to which the node is to be joined to comprise the first node at act 507. At act 508, group management protocol component 540 may indicate to configuration consensus engine 535 that the first node has successfully merged with the cluster and thus has been accepted to operate with the cluster. For each node indicated at act 501 and provided to the cluster join coordinator 525 at act 503, acts 506, 507, and 508 may be repeated until all of the nodes have been successfully merged with the cluster. Thus, the batch of nodes indicated at act 501 may be automatically added one-by-one at acts 506, 507 and 508 without undermining a quorum and determining of a consensus with respect to each one of the nodes, which could occur if the merge flags corresponding to all of the nodes were not set to ‘false’ at act 505 and were instead the merge flags were all set to ‘true’ and provided to group management protocol module 540 substantially simultaneously (e.g., ability to obtain consensus for any inactive node to be added to the cluster could be undermined if all nodes were marked as merge=‘true’ and thus considered according to a consensus protocol, such as, for example, Paxos, all at once). At act 507, user 510 may monitor an interface to determine progress with respect to the nodes corresponding to the serial numbers or other indicators indicated at 501 being joined to a cluster indicated at act 501. It will be appreciated that after user 510 enters multiple computing resource node serial numbers or node indicators at act 501 user 510 need not monitor progress and need not manually enter the serial numbers one-by-one as the nodes are configured to operate with the cluster.

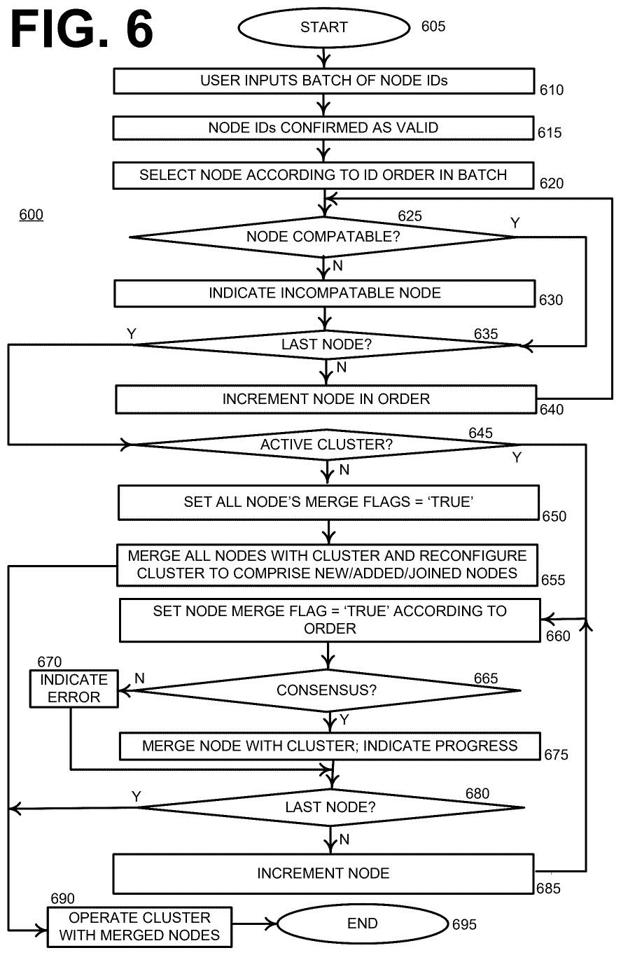

Turning now to FIG. 6, the figure illustrates a flow diagram of steps of a method 600 to join a batch of computing resource nodes to a computing resource cluster. Method 600 begins at step 605. At step 610, a user may input a batch, or multiple, node identifiers corresponding to multiple nodes to be added to a cluster. The user may input the node identifiers via a user interface coupled with a computing system, which may be coupled to a communication network to which the cluster may also be coupled. At act 615, the computing system may confirm node identifiers input as being valid with respect to format or with respect to another criterion. At act 620, the computing system may select a node identifier from the batch of node identifiers input at act 610. At act 625, the computing system may determine whether a node corresponding to the node identifier selected at act 620 (or as incremented at act 640) is compatible with the cluster to which the nodes corresponding to the node identifiers entered at act 610 are to be added. For example, if a node corresponding to the node identifier selected at act 620 is not compatible with an operating system corresponding to the cluster, or if a hardware or software incompatibility is determined to exist with respect to the cluster, the node corresponding to the identifier selected at act 620 may be indicated at act 630 as incompatible with the cluster. Method 600 may advance to act 635.

Returning to description of act 625, if the computing system determines that a node corresponding to and identifier selected act 620 is compatible with the cluster to which the node is to be added, method 600 may advance to act 635. At act 635, the computing system may determine whether a node selected at act 620, or that results from an incrementing at act 640 of node identifiers according to an order of the nodes input at act 610, is a last node identifier of the nodes input at act 610 and method 600 may advance from act 635 to act 645. (E.g., after all nodes input at act 610 have been evaluated as being compatible or incompatible with the cluster, method 600 may advance to act 645.)

At act 645, the computing system may determine whether the cluster to which the nodes corresponding to the node identifiers input at act 610 are to be added is an active cluster or an inactive cluster. For example, an inactive cluster may be a new cluster that is being built and that has not been deployed for use, and to which nodes are being added, or configured for use with, whereas an active cluster may be an existing cluster that has already been put into production, or deployed for use, and to which new nodes are to be added/merged/joined.

If a determination is made at act 645 that a cluster to which the nodes are to be added is not an active cluster, method 600 may advance to act 650. At act 650, the computing system may set a merge flag corresponding to all nodes to be merged with the cluster to ‘true’ and an operating system corresponding to the cluster may at act 655 merge all nodes with the cluster. Although merging all nodes of the cluster may be time consuming, because the cluster is not yet in production the time delay may be immaterial to an end user of the cluster. After the nodes have been merged at act 655 with the cluster, at act 690 the cluster may be operated with the merged nodes and method 600 may advance to act 695 and end.

Returning to description of act 645, if a determination is made that the cluster to which the nodes are to be added is an active cluster, method 600 may advance to act 660. At act 660, the computing system may set a merge flag to ‘true’ with respect to a single node of the multiple nodes to be joined to the cluster. At act 665, an operating system, operative with respect to the cluster, or the computing system, may determine whether a consensus with respect to nodes corresponding to the cluster has been determined with respect to adding, or merging, the node indicated at act 660 as ‘true.’ If a determination is made that a consensus with respect to the node indicated by the merge flag being set at act 660 as ‘true’ has not been reached, at act 670 the operating system may indicate to the computing system or the computing system may indicate to the user that the node indicated by the merge flag being set at act 660 as ‘true’ is not compatible with the cluster and method 600 may advance to act 680.

At act 680, the computing system may determine whether the node indicated by the merge flag being set at act 660 as ‘true’ is a last of the nodes to be added to the cluster. If the computing system determines that the node indicated by the merge flag being set at act 660 as ‘true’ is not the last node to be added to the cluster, the computing system may increment the node identifier according to an order of the node identifiers indicated at act 610 and method 600 may return to act 660. After method 600 returns from act 685 to act 660, the computing system may set a merge flag corresponding to the next node in the order of node identifiers that is incremented at act 685 as being ‘true.’ If a determination is made at act 665 that a consensus is reached with respect to a node corresponding to a merge flag being set ‘true’ at act 660, method 600 may advance to act 675. At act 675, the node corresponding to the merge flag being set to true at act 660 may be merged with the cluster. Progress of the node being merged at act 675 may be available or may be indicated to a user. However, a user need not monitor progress of nodes being merged at act 675 before method 600 advances from act 675.

Method 600 may repeat acts 665, 670, 675, 685, and 680 according to an order of the node identifiers input at act 610 until a determination is made at act 680 that all nodes corresponding to the node identifiers have been merged with the cluster or have been rejected for merger with the cluster based on a consensus with respect to the node not being reached, for example, by a consensus protocol such as Paxos, that may correspond to the operating system corresponding to the cluster. If a determination is made at act 680 that nodes to be added to an active cluster have been merged with the cluster, or that nodes to be added to the cluster are indicated as having not received a consensus for being merged with the cluster, method 600 may advance to 690 and as described above the cluster may operate with nodes with respect to which consensus was reached at act 665. Method 600 advances from act 690 to act 695 and ends.

Accordingly, with respect to an active cluster to which new nodes are to be merged, only setting a merge flag, or flags, corresponding to one node, or fewer nodes than all nodes, to be added to the cluster at act 650 may facilitate avoiding an operating system corresponding to the cluster being unable to determine a consensus with respect to the clusters, which inability to determine a consensus could occur if the computing system indicated, all at once, to the operating system corresponding to the cluster, the batch of node identifiers, input at act 610, corresponding to the batch of nodes to be merged with the cluster.

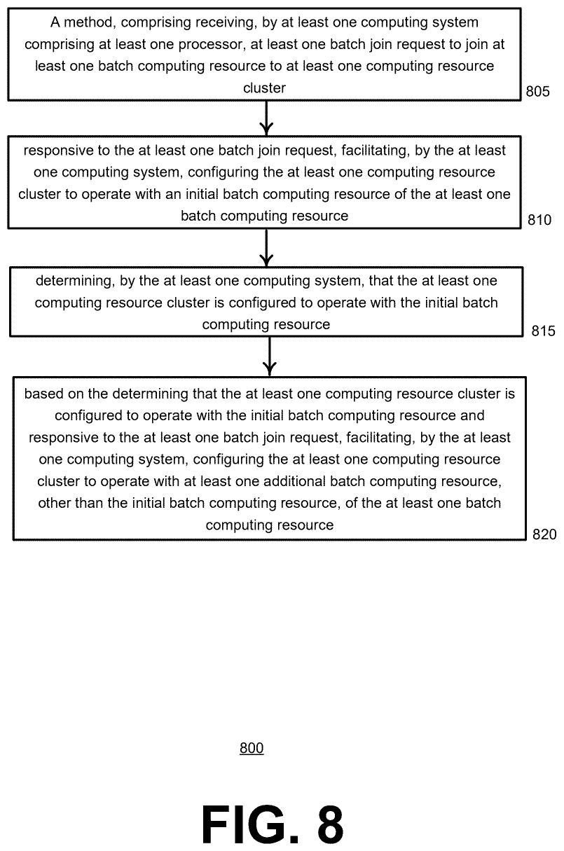

Turning now to FIG. 8, the figure illustrates an exemplary embodiment method 800 comprising at block 805 receiving, by at least one computing system comprising at least one processor, at least one batch join request to join at least one batch computing resource to at least one computing resource cluster; at block 810, responsive to the at least one batch join request, facilitating, by the at least one computing system, configuring the at least one computing resource cluster to operate with an initial batch computing resource of the at least one batch computing resource; at block 815 determining, by the at least one computing system, that the at least one computing resource cluster is configured to operate with the initial batch computing resource; and at block 820, based on the determining that the at least one computing resource cluster is configured to operate with the initial batch computing resource and responsive to the at least one batch join request, facilitating, by the at least one computing system, configuring the at least one computing resource cluster to operate with at least one additional batch computing resource, other than the initial batch computing resource, of the at least one batch computing resource.

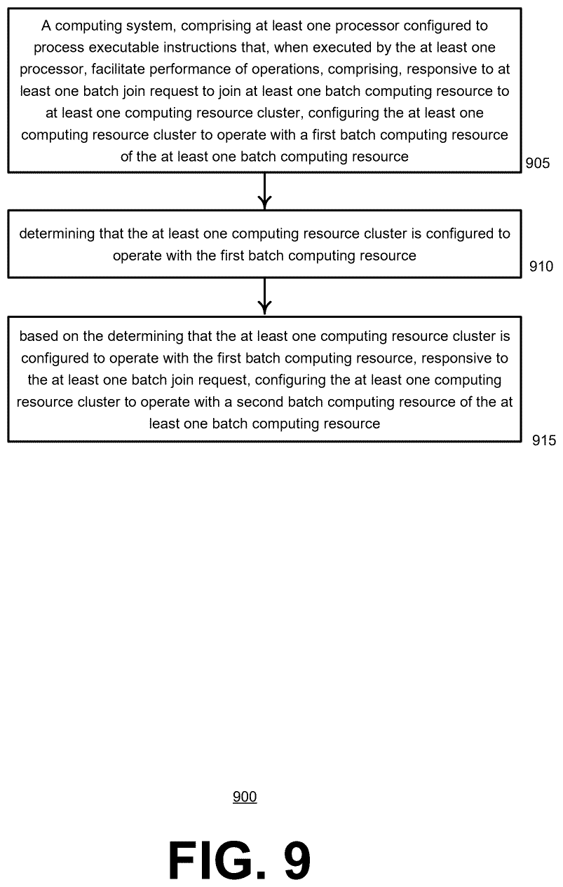

Turning now to FIG. 9, the figure illustrates an exemplary computing system embodiment 900, comprising, at block 905, at least one processor configured to process executable instructions that, when executed by the at least one processor, facilitate performance of operations, comprising, responsive to at least one batch join request to join at least one batch computing resource to at least one computing resource cluster, configuring the at least one computing resource cluster to operate with a first batch computing resource of the at least one batch computing resource; at block 910 determining that the at least one computing resource cluster is configured to operate with the first batch computing resource; and at block 915, based on the determining that the at least one computing resource cluster is configured to operate with the first batch computing resource, responsive to the at least one batch join request, configuring the at least one computing resource cluster to operate with a second batch computing resource of the at least one batch computing resource.

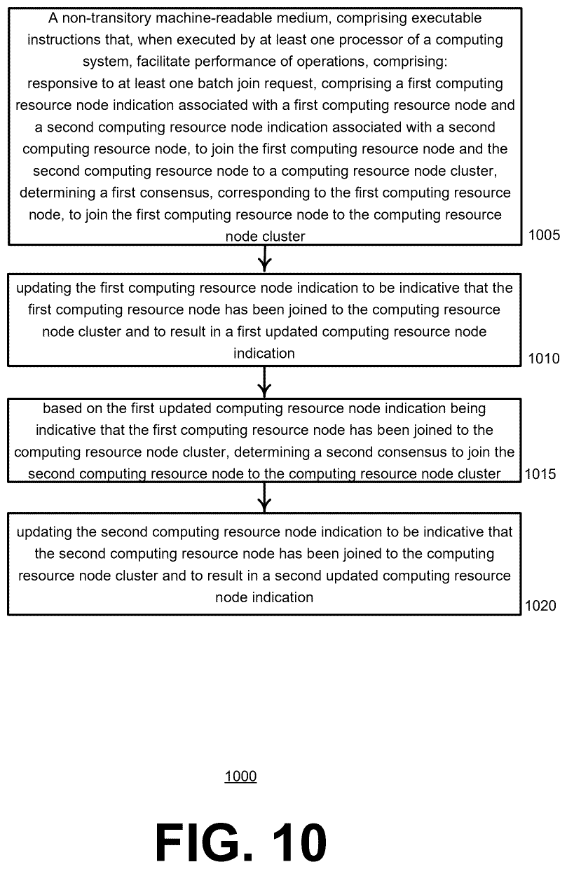

Turning now to FIG. 10, the figure illustrates an exemplary non-transitory machine-readable medium, comprising executable instructions that, when executed by at least one processor of a computing system, facilitate performance of operations, comprising at block 1005, responsive to at least one batch join request, comprising a first computing resource node indication associated with a first computing resource node and a second computing resource node indication associated with a second computing resource node, to join the first computing resource node and the second computing resource node to a computing resource node cluster, determining a first consensus, corresponding to the first computing resource node, to join the first computing resource node to the computing resource node cluster; at block 1010 updating the first computing resource node indication to be indicative that the first computing resource node has been joined to the computing resource node cluster and to result in a first updated computing resource node indication; at block 1015, based on the first updated computing resource node indication being indicative that the first computing resource node has been joined to the computing resource node cluster, determining a second consensus to join the second computing resource node to the computing resource node cluster; and at block 1020 updating the second computing resource node indication to be indicative that the second computing resource node has been joined to the computing resource node cluster and to result in a second updated computing resource node indication.

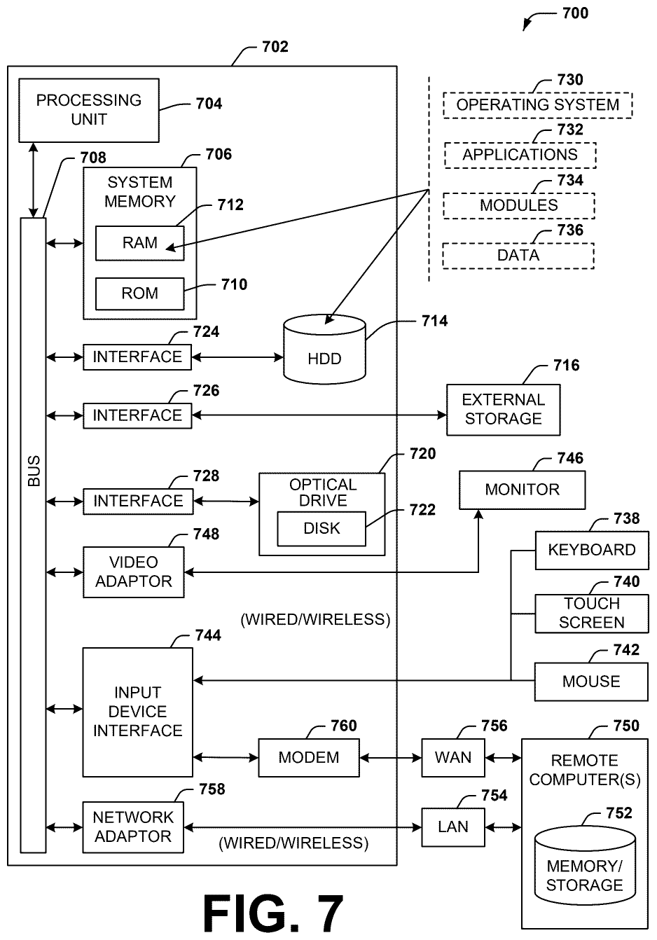

In order to provide additional context for various embodiments described herein, FIG. 7 and the following discussion are intended to provide a brief, general description of a suitable computing environment 700 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 7, the example environment 700 for implementing various embodiments of the aspects described herein includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors and may include a cache memory. Dual microprocessors and other multi-processor architectures can also be employed as the processing unit 704.

The system bus 708 can be any of several types of bus structure that can further interconnect to a memory bus (with or without a memory controller), a peripheral bus, and a local bus using any of a variety of commercially available bus architectures. The system memory 706 includes ROM 710 and RAM 712. A basic input/output system (BIOS) can be stored in a non-volatile memory such as ROM, erasable programmable read only memory (EPROM), EEPROM, which BIOS contains the basic routines that help to transfer information between elements within the computer 702, such as during startup. The RAM 612 can also include a high-speed RAM such as static RAM for caching data.

Computer 702 further includes an internal hard disk drive (HDD) 714 (e.g., EIDE, SATA), one or more external storage devices 716 (e.g., a magnetic floppy disk drive (FDD) 716, a memory stick or flash drive reader, a memory card reader, etc.) and an optical disk drive 720 (e.g., which can read or write from a CD-ROM disc, a DVD, a BD, etc.). While the internal HDD 714 is illustrated as located within the computer 702, the internal HDD 714 can also be configured for external use in a suitable chassis (not shown). Additionally, while not shown in environment 700, a solid-state drive (SSD) could be used in addition to, or in place of, an HDD 714. The HDD 714, external storage device(s) 716 and optical disk drive 720 can be connected to the system bus 708 by an HDD interface 724, an external storage interface 726 and an optical drive interface 728, respectively. The interface 724 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 702, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 712, including an operating system 730, one or more application programs 732, other program modules 734 and program data 736. All or portions of the operating system, applications, modules, and/or data can also be cached in the RAM 712. The systems and methods described herein can be implemented utilizing various commercially available operating systems or combinations of operating systems.

Computer 702 can optionally comprise emulation technologies. For example, a hypervisor (not shown) or other intermediary can emulate a hardware environment for operating system 730, and the emulated hardware can optionally be different from the hardware illustrated in FIG. 7. In such an embodiment, operating system 730 can comprise one virtual machine (VM) of multiple VMs hosted at computer 702. Furthermore, operating system 730 can provide runtime environments, such as the Java runtime environment or the .NET framework, for applications 732. Runtime environments are consistent execution environments that allow applications 732 to run on any operating system that includes the runtime environment. Similarly, operating system 730 can support containers, and applications 732 can be in the form of containers, which are lightweight, standalone, executable packages of software that include, e.g., code, runtime, system tools, system libraries and settings for an application.

Further, computer 702 can comprise a security module, such as a trusted processing module (TPM). For instance, with a TPM, boot components hash next in time boot components, and wait for a match of results to secured values, before loading a next boot component. This process can take place at any layer in the code execution stack of computer 602, e.g., applied at the application execution level or at the operating system (OS) kernel level, thereby enabling security at any level of code execution.

A user can enter commands and information into the computer 702 through one or more wired/wireless input devices, e.g., a keyboard 738, a touch screen 740, and a pointing device, such as a mouse 742. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 704 through an input device interface 744 that can be coupled to the system bus 708, but can be connected by other interfaces, such as a parallel port, an IEEE 1394 serial port, a game port, a USB port, an IR interface, a BLUETOOTH® interface, etc.

A monitor 746 or other type of display device can be also connected to the system bus 608 via an interface, such as a video adapter 748. In addition to the monitor 746, a computer typically includes other peripheral output devices (not shown), such as speakers, printers, etc.

The computer 702 can operate in a networked environment using logical connections via wired and/or wireless communications to one or more remote computers, such as a remote computer(s) 750. The remote computer(s) 750 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 752 is illustrated. The logical connections depicted include wired/wireless connectivity to a local area network (LAN) 754 and/or larger networks, e.g., a wide area network (WAN) 756. Such LAN and WAN networking environments are commonplace in offices and companies, and facilitate enterprise-wide computer networks, such as intranets, all of which can connect to a global communications network, e.g., the internet.

When used in a LAN networking environment, the computer 702 can be connected to the local network 754 through a wired and/or wireless communication network interface or adapter 758. The adapter 758 can facilitate wired or wireless communication to the LAN 754, which can also include a wireless access point (AP) disposed thereon for communicating with the adapter 758 in a wireless mode.

When used in a WAN networking environment, the computer 702 can include a modem 760 or can be connected to a communications server on the WAN 756 via other means for establishing communications over the WAN 756, such as by way of the internet. The modem 760, which can be internal or external and a wired or wireless device, can be connected to the system bus 708 via the input device interface 744. In a networked environment, program modules depicted relative to the computer 702 or portions thereof, can be stored in the remote memory/storage device 752. It will be appreciated that the network connections shown are example and other means of establishing a communications link between the computers can be used.

When used in either a LAN or WAN networking environment, the computer 702 can access cloud storage systems or other network-based storage systems in addition to, or in place of, external storage devices 716 as described above. Generally, a connection between the computer 702 and a cloud storage system can be established over a LAN 754 or WAN 756 e.g., by the adapter 758 or modem 760, respectively. Upon connecting the computer 702 to an associated cloud storage system, the external storage interface 726 can, with the aid of the adapter 758 and/or modem 760, manage storage provided by the cloud storage system as it would other types of external storage. For instance, the external storage interface 726 can be configured to provide access to cloud storage sources as if those sources were physically connected to the computer 702.

The computer 702 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
receiving, by at least one computing system comprising at least one processor, at least one batch join request to join at least one batch computing resource to at least one computing resource cluster;
responsive to the at least one batch join request, facilitating, by the at least one computing system, configuring the at least one computing resource cluster to operate with an initial batch computing resource of the at least one batch computing resource;
determining, by the at least one computing system, that the at least one computing resource cluster is configured to operate with the initial batch computing resource; and
based on the determining that the at least one computing resource cluster is configured to operate with the initial batch computing resource and responsive to the at least one batch join request, facilitating, by the at least one computing system, configuring the at least one computing resource cluster to operate with at least one additional batch computing resource, other than the initial batch computing resource, of the at least one batch computing resource.

2. The method of claim 1, wherein, before the determining that the at least one computing resource cluster is configured to operate with the initial batch computing resource, the initial batch computing resource is associated with an initial operational status indication indicative that the initial batch computing resource is available to operate as part of the at least one computing resource cluster.

3. The method of claim 2, wherein, before the determining that the at least one computing resource cluster is configured to operate with the initial batch computing resource, the at least one additional batch computing resource is associated with at least one additional operational status indication indicative that the at least one additional batch computing resource is available to operate as part of the at least one computing resource cluster.

4. The method of claim 3, wherein, before the configuring the at least one computing resource cluster to operate with the at least one additional batch computing resource, the at least one additional batch computing resource is associated with at least one additional nonoperational status indication indicative that the at least one additional batch computing resource is not available to operate as part of the at least one computing resource cluster, and wherein, after the configuring of the at least one computing resource cluster to operate with the initial batch computing resource, the at least one additional batch computing resource is associated with at least one additional operational status indication indicative that the at least one additional batch computing resource is available to operate as part of the at least one computing resource cluster.

5. The method of claim 4, wherein the at least one additional batch computing resource is at least one first additional batch computing resource, wherein the at least one additional nonoperational status indication is at least one first nonoperational status indication indicative that the at least one first additional batch computing resource is not available to operate as part of the at least one computing resource cluster, wherein the at least one additional operational status indication is at least one first additional operational status indication indicative that the at least one first additional batch computing resource is available to operate as part of the at least one computing resource cluster, and wherein the method further comprises:
determining, by the at least one computing system, that the at least one computing resource cluster is configured to operate with the at least one first additional batch computing resource; and
based on the determining that the at least one computing resource cluster is configured to operate with the at least one first additional batch computing resource and responsive to the at least one batch join request, facilitating, by the at least one computing system, configuring the at least one computing resource cluster to operate with at least one second additional batch computing resource, other than the initial batch computing resource and other than the at least one first additional batch computing resource, of the at least one batch computing resource.

6. The method of claim 5, wherein the at least one batch join request comprises an initial batch resource indication indicative of the initial batch computing resource, at least one first additional batch resource indication indicative of the at least one first additional batch computing resource, and at least one second additional batch resource indication indicative of the at least one second additional batch computing resource.

7. The method of claim 6, wherein the at least one batch join request comprises an initial batch computing resource identifier associated with the initial batch computing resource, at least one first additional batch computing resource identifier associated with the at least one first additional batch computing resource, and at least one second additional batch computing resource identifier associated with the at least one second additional batch computing resource.

8. The method of claim 7, wherein the initial batch computing resource identifier corresponds to an initial value, wherein the at least one first additional batch computing resource identifier comprises at least one first additional value, and wherein the at least one second additional batch computing resource identifier comprises at least one second additional value.

9. The method of claim 8, wherein the configuring of the at least one computing resource cluster to operate with the initial batch computing resource, the at least one first additional batch computing resource, and the at least one second additional batch computing resource is facilitated according to the initial value, the at least one first additional value, and the at least one second additional value, respectively.

10. The method of claim 1, wherein the at least one computing system comprises the at least one computing resource cluster.

11. The method of claim 1, wherein the facilitating of the configuring of the at least one computing resource cluster to operate with the initial batch computing resource, the determining that the at least one computing resource cluster is configured to operate with the initial batch computing resource, and the facilitating of the configuring of the at least one computing resource cluster to operate with the at least one additional batch computing resource are independent of any user input.

12. The method of claim 1, wherein the at least one computing resource cluster is determined to be configured to operate with the initial batch computing resource or the at least one additional batch computing resource according to a configured merged computing resource acknowledgement frequency.

13. A computing system, comprising at least one processor configured to process executable instructions that, when executed by the at least one processor, facilitate performance of operations, comprising:
responsive to at least one batch join request to join at least one batch computing resource to at least one computing resource cluster, configuring the at least one computing resource cluster to operate with a first batch computing resource of the at least one batch computing resource;
determining that the at least one computing resource cluster is configured to operate with the first batch computing resource; and
based on the determining that the at least one computing resource cluster is configured to operate with the first batch computing resource, responsive to the at least one batch join request, configuring the at least one computing resource cluster to operate with a second batch computing resource of the at least one batch computing resource.

14. The computing system of claim 13, wherein, before the determining that the at least one computing resource cluster is configured to operate with the first batch computing resource, the second batch computing resource is associated with a first nonoperational status indication indicative that the second batch computing resource has not been indicated as being capable to merge with the at least one computing resource cluster, and wherein, after the determining that the at least one computing resource cluster is configured to operate with the first batch computing resource, the operations further comprise:
setting a first merge flag associated with the second batch computing resource to be indicative that the second batch computing resource is capable of being merged with the at least one computing resource cluster.

15. The computing system of claim 14, wherein the configuring of the at least one computing resource cluster to operate with the second batch computing resource is based on the first merge flag being indicative that the second batch computing resource is capable of being merged with the at least one computing resource cluster.

16. The computing system of claim 13, wherein the configuring of the at least one computing resource cluster to operate with the first batch computing resource comprises a first consensus, corresponding to the at least one computing resource cluster, being determined that the first batch computing resource has been accepted for operation with respect to the at least one computing resource cluster.

17. The computing system of claim 16, wherein the configuring of the at least one computing resource cluster to operate with the second batch computing resource comprises a second consensus being determined that the second batch computing resource has been accepted for operation with respect to the at least one computing resource cluster, and wherein the second consensus is not determined until after the first batch computing resource has been joined to the at least one computing resource cluster.

18. The computing system of claim 16, wherein the at least one computing resource cluster comprises at least one cluster node, and wherein the first batch computing resource and the second batch computing resource comprise first and second cluster nodes, respectively, indicated by the at least one batch join request to be added to the at least one computing resource cluster.

19. A non-transitory machine-readable medium, comprising executable instructions that, when executed by at least one processor of a computing system, facilitate performance of operations, comprising:
responsive to at least one batch join request, comprising a first computing resource node indication associated with a first computing resource node and a second computing resource node indication associated with a second computing resource node, to join the first computing resource node and the second computing resource node to a computing resource node cluster, determining a first consensus, corresponding to the first computing resource node, to join the first computing resource node to the computing resource node cluster;
updating the first computing resource node indication to be indicative that the first computing resource node has been joined to the computing resource node cluster and to result in a first updated computing resource node indication;
based on the first updated computing resource node indication being indicative that the first computing resource node has been joined to the computing resource node cluster, determining a second consensus to join the second computing resource node to the computing resource node cluster; and
updating the second computing resource node indication to be indicative that the second computing resource node has been joined to the computing resource node cluster and to result in a second updated computing resource node indication.

20. The non-transitory machine-readable medium of claim 19, wherein the first consensus is determined with respect to the first computing resource node, and wherein the first consensus is not determined with respect to the second computing resource node according to an order of the first computing resource node indication and the second computing resource node indication based on the at least one batch join request.
